(19) United States
(12) Patent Application Publication
(10) Pub. No.: US 2022/0121856 A1
(43) Pub. Date: Apr. 21, 2022

(54) VIDEO IMAGE PROCESSING APPARATUS, VIDEO IMAGE PROCESSING METHOD, AND STORAGE MEDIUM

(71) Applicant: CANON KABUSHIKI KAISHA, Tokyo (JP)

(72) Inventor: Shunsuke Sato, Kanagawa (JP)

(21) Appl. No.: 17/477,731

(22) Filed: Sep. 17, 2021

(30) Foreign Application Priority Data
Oct. 15, 2020 (JP) 2020-173769

(51) Int. Cl. G06K 9/00

(52) U.S. Cl. CPC G06K 9/00751; G06K 9/00335; G06K 9/00771; G06K 9/00718

(57) ABSTRACT

A video image processing apparatus includes a video image acquisition unit that acquires video images, a period selection unit that selects, from the video images acquired by the video image acquisition unit, a plurality of time periods in which a predetermined subject performed a predetermined movement, and a synthesizing unit that synthesizes a video image from the plurality of time periods that have been selected by the period selection unit by bringing them closer together in time, in order to synthesize a summary video image with good visibility based on the time periods in which a predetermined subject performed a predetermined movement.

### BACKGROUND OF THE INVENTION

### Field of the Invention

The present invention relates to a video image processing apparatus and the like that can create summaries and the like of video images.

### Description of the Related Art

Video image processing technology provides a method for the creation of a summary video image that makes the contents of long videos easy to check by summarizing them.

For example, the specification of U.S. Pat. No. 9,877,086 provides a technique for creating a summary video image that narrows down and simultaneously displays subjects from different times using conditions that have been specified by the user (viewer) such as clothing, age, and the like.

In contrast, for example, in a case in which the user would like to create a summary video image of a subject that has performed a specific predetermined action, it is anticipated that, out of the range in which the subject appears in the video image, the user (viewer) would like to focus on the period in which the subject performs the action that has been specified.

Due to this, if when and where the subject performed the action that should be focused on are not taken into consideration, there is a possibility that a summary video image with poor observability will be created. For example, if multiple subjects who are in the middle of performing the action that should be focused on overlap, it is possible that observation will be hindered. The present invention has been made in view of the above drawbacks, and one of objects is to generate a summary video image with good observability based on a time period during which a predetermined subject performed a predetermined movement.

### SUMMARY OF THE INVENTION

In order to solve the above problems, a video image processing apparatus of one aspect of the inventions includes:
a video image acquisition unit configured to acquire video images;
a period selection unit configured to select, from the video images that have been acquired by the video image acquisition unit, a plurality of time periods in which a predetermined subject has performed a predetermined movement; and
a synthesizing unit configured to synthesize the video images from the plurality of time periods that have been selected by the period selection unit by bringing them closer together in time.

Further features of the present invention will become apparent from the following description of embodiments with reference to the attached drawings.

### BRIEF DESCRIPTION OF THE DRAWINGS

FIG. 1 illustrates the overall configuration of a video image processing apparatus (video image processing system) in Embodiment 1 of the present invention.

FIG. 2 is a block diagram of the functions of a video image processing apparatus (video image processing system) in Embodiment 1.

FIGS. 3A, 3B, 3C, and 3D are schematic diagrams explaining examples of subjects' movement in Embodiment 1. FIG. 3A is a schematic diagram that illustrates an example of a video image captured by the image capturing unit. FIGS. 3B, 3C, and 3D are schematic diagrams that illustrate examples of people who reached out their hand to the product shelf and have been recorded in the summary original video image.

FIGS. 4A. 4B, 4C1, 4C2, 4C3, 4C4, 4C5, and 4C6 are drawings that explain the method of creating a summary video image from a summary original video image in Embodiment 1. FIG. 4A is a timeline drawing illustrating the appearance times of the people who are included in the summary original video image. FIG. 4B is a drawing that explains an example of a video image that summarizes the summary original video image. FIGS. 4C1, 4C2, 4C3, 4C4, 4C5, and 4C6 are schematic diagrams of representative frames of the summary video images illustrated in FIG. 4B, each of which illustrates each of the time frame images that are shown as alternate long and short dotted lines in FIG. 4B.

FIG. 5 is a flow chart illustrating the order of processing carried out by a video image processing apparatus in Embodiment 1.

FIG. 6 is a drawing that illustrates an example of a settings screen displayed by a display unit 210 in Embodiment 1.

FIG. 7 is a flowchart illustrating a detailed example of the order of processing in step S507 in Embodiment 1.

FIGS. 8A, 8B, 8C, 8D, 8E are drawings that explain the changes to a time period sequence M in the processing in step S507 in Embodiment 1. FIG. 8A is an example of M and H′ᵢ directly before step S704. FIG. 8B illustrates M and (H′ᵢ+Tᵢ) when the flow has proceeded to steps S704 and S705. FIG. 8C illustrates an example when has been added to Tᵢ in step S707. FIG. 8D illustrates an example where U₂ has been added to Tᵢ in step S707. FIG. 8E is the new M, which has been merged with H′ᵢ in step S710.

FIGS. 9A and 9B are drawings that illustrate examples of a summary video image in Embodiment 2 of the present invention. FIG. 9A is a schematic diagram that explains the contents of a summary video image in the present embodiment. FIG. 9B is the timeline of this summary video image.

FIG. 10 is a flowchart illustrating an example of the processing in step S507 in Embodiment 2.

FIGS. 11A, 11B, and 11C are drawings that explain the processing in step S1005 of Embodiment 2. FIG. 11A and FIG. 11B are schematic diagrams that illustrate the summary target people belonging to the same group. FIG. 11C illustrates the purpose for preventing overlapping by parallelly displacing each person in diverging directions.

FIGS. 12A and 12B are drawings that explain summary video images in Embodiment 3 of the present invention. FIG. 12A is a schematic diagram of one time period from a summary original video image in an example in which an automobile road is being captured by the image capturing unit. FIG. 12B is a schematic diagram that illustrates an example of the video image that summarizes from the summary original video image in FIG. 12A.

### DETAILED DESCRIPTION OF THE INVENTION

The best mode for carrying out the present invention will be described below using the embodiments with reference to the appended drawings. Note that, in each of the drawings, the same reference numbers are attached to the same members or elements, and redundant descriptions are omitted or simplified.

In addition, the following embodiments will explain an example which applies a network camera as the image capturing apparatus. However, the image capturing apparatus includes electronic devices and the like that have image capturing functions, such as digital still cameras, digital movie cameras, smartphones equipped with cameras, tablet computers equipped with cameras, on-board cameras, and the like.

### Embodiment 1

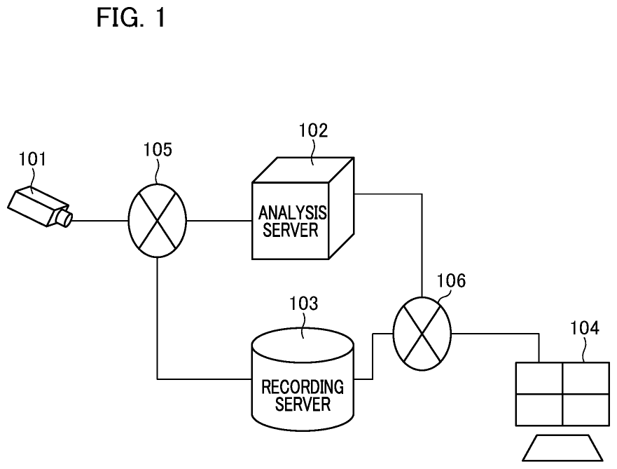

FIG. 1 is a drawing that illustrates the overall configuration of the video image processing apparatus (video image processing system) in Embodiment 1 of the present invention.

A network camera 101 comprises an image capturing element, a lens, a motor that drives the video capturing element and the lens, a CPU (Central Processing Unit) that controls these, an MPU (Micro-processing unit), a memory, and the like.

Furthermore, the network camera 101 is an image capturing apparatus that is provided with the above configurations, wherein videos are captured and converted into electronic video data. The network camera 101 is installed in an area that the user (viewer) needs to monitor, and sends the captured video images via a camera network 105.

An analysis server 102 includes a CPU, an MPU, a memory and the like serving as a computer, and analyses video images that are sent from the network camera 101 and the like, or video images that have been recorded on a recording server 103. The analysis server 102 performs recognition processing according to its instillation area such as, for example, facial recognition, person tracking, crowd flow measurement, intruder detection, personal attribute detection, weather detection, or detection, aggregates the results and notifies the user according to the settings.

A recording server 103 records on storage media the video images that have been acquired from the network camera 101, and sends the video images that have been recorded according to requests from the analysis server 102, a client terminal apparatus 104, and the like. In addition, the recording server 103 also combines and saves the metadata that indicates the analysis results from the analysis server 102 and the like.

The recording server 103 comprises a recording media such as a hard disk serving as a storage, and a CPU, an MPU, a ROM, and the like. Storage on a network such as a NAS (Network Attached Storage), a SAN (Storage Area Network), or a cloud service may be used instead of a recording media.

A client terminal apparatus 104 is an apparatus that includes a CPU, an MPU, a memory, and the like as a computer that is connected to a display, and a keyboard serving as a controller, and the like. The client terminal apparatus 104 checks the video images from the network camera 101 by acquiring them via the recording server 103, and performs monitoring. In addition, the client terminal apparatus 104 checks the past video images that have been recorded on the recording server 103, checks these images together with the analysis results from the analysis server 102, and receives notifications.

The network camera 101, the analysis server 102, and the recording server 103 are connected by a camera network 105. In addition, the analysis server 102, the recording server 103, and the client terminal apparatus 104 are connected by a client network 106.

The camera network 105 and the client network 106 are configured, for example, by a LAN.

Note that, although in the video image processing apparatus (the video image processing system) of the present embodiment, the network camera 101, the analysis server 102, the recording server 103, and the client terminal apparatus 104 are different computer apparatuses, the present embodiment is not limited to such configurations. The entirety of the plurality of these apparatuses may be configured as one apparatus, or a portion of the apparatuses may be combined.

For example, the analysis server 102 and the recording server 103 may be configured as an application and a virtual server in one server apparatus. In addition, at least one function of the analysis server 102 and the recording server 103 may be provided in the client terminal apparatus 104, or the network camera 101 may be equipped with the functions of the analysis server 102 and the recording server 103.

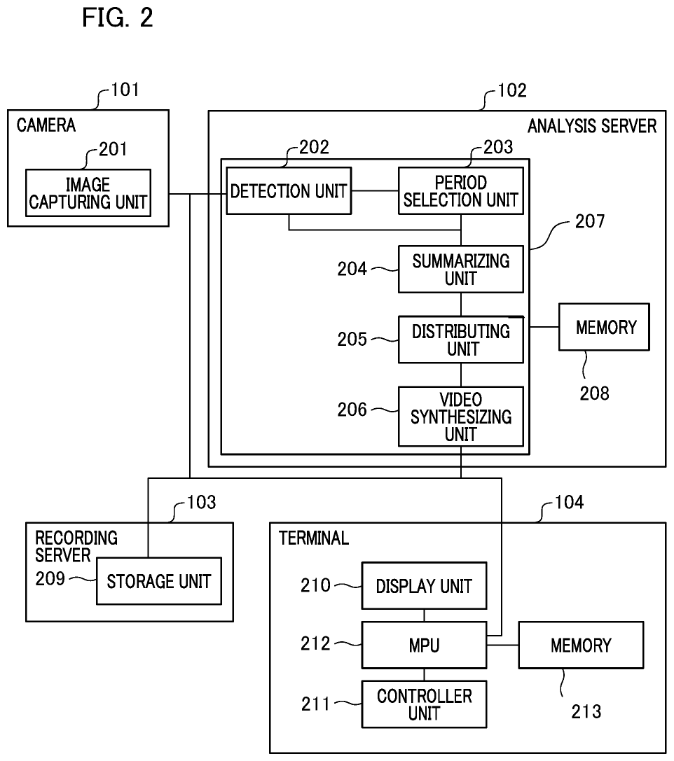

FIG. 2 is a block diagram of the functions of the video image processing apparatus (video image processing system) in Embodiment 1.

The present video image processing apparatus includes an image capturing unit 201, a detection unit 202, a period selection unit 203, a summarizing unit 204, a distributing unit 205, a video synthesizing unit 206, a storage unit 209, a display unit 210, a controller unit 211, and the like. The analysis server 102 includes an MPU 207 and a memory 208 that has stored a computer program.

An image capturing unit 201 corresponds to the network camera 101 that is illustrated in FIG. 1. The image capturing unit 201 captures video images, converts them into a stream of electronic image data, and sends them to the analysis server 102 and the recording server 103.

A detection unit 202, a period selection unit 203, a summarizing unit 204, a distributing unit 205, and a video image synthesizing unit 206 are included in the analysis server 102, and are configured as a software module and the like when the MPU 207 executes the computer program that has been stored in the memory 208.

A detection unit 202 detects subjects that belong to a predetermined category from the video images that have been acquired from storage mediums such as the image capturing unit 201, the recording server 103 and the like, and additionally determines a chronological path for the subject by tracking the subject. That is, the detection unit 202 functions as a video image acquisition unit that acquires video images.

A period selection unit 203 selects a time series of feature time periods for the tracking path of the subject that has been detected by the detection unit 202 based on the conditions that have been specified by the user. That is, the period selection unit 203 functions as a period selection unit that selects, from the video images that have been acquired by the video image acquisition unit, a plurality of time periods in which a predetermined subject performed a predetermined movement.

The period selection unit 203 performs the extraction of a temporally changing feature value for each subject, and selects a time period using the results of that feature value extraction. In some cases, a plurality of time periods will be selected from the tracking path of one subject, or it is also possible that none will be selected.

A summarizing unit 204 selects the video images of the subject that has been detected by the detection unit 202 that will be included in the summarized video image (displayed) based on the conditions specified by the user.

A distributing unit 205 is configures by an MPU and the like, and determines the temporal distribution in the summarized video image of the subject that has been selected by the summarizing unit 204.

A video image synthesizing unit 206 synthesizes a summary video image according to the determinations of the distributing unit 205. A synthesizing unit, which synthesizes video images from the plurality of time periods that have been selected by the period selection unit by bringing them closer together in time, comprises the summarizing unit 204, the distributing unit 205, the video image synthesizing unit 206, and the like.

A storage unit 209 corresponds to the storage of the recording server 103 that is illustrated in FIG. 1.

The storage unit 209 is configured by a storage media such as a hard disk, an MPU, and the like, and saves the video images that have been captured by the image capturing unit 201. In addition, it also saves the video images in association with the metadata such as their category, information regarding their interrelationships, and the time of their creation.

A display unit 210 and a controller unit 211 are included in the client terminal apparatus 104 that is illustrated in FIG. 1. The client terminal apparatus 104 further includes an MPU 212 and a memory 213 that stores a computer program.

The display unit 210 includes a display device such as a liquid crystal screen, or the like. The display screen is controlled by an MPU 212, or the like, provides the user with information, and creates and displays a user interface (UI) screen for performing operations.

The controller unit 211 is configured by a switch, a touch panel, and the like, detects the operations of the user and inputs them to the client terminal apparatus 104.

Note that the controller unit 211 may also include a pointing device such as a mouse, a trackball, or the like, not just a touch panel.

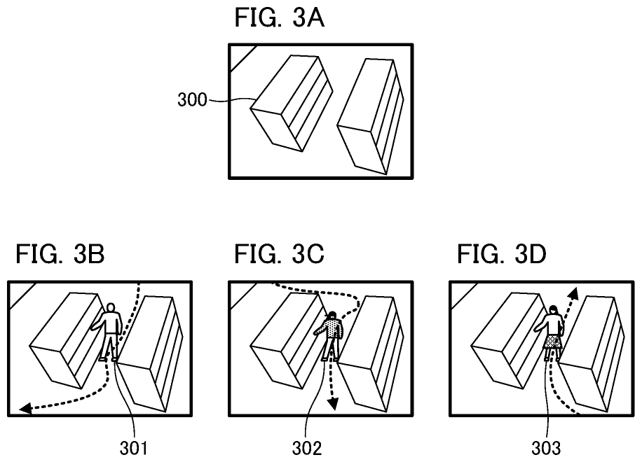

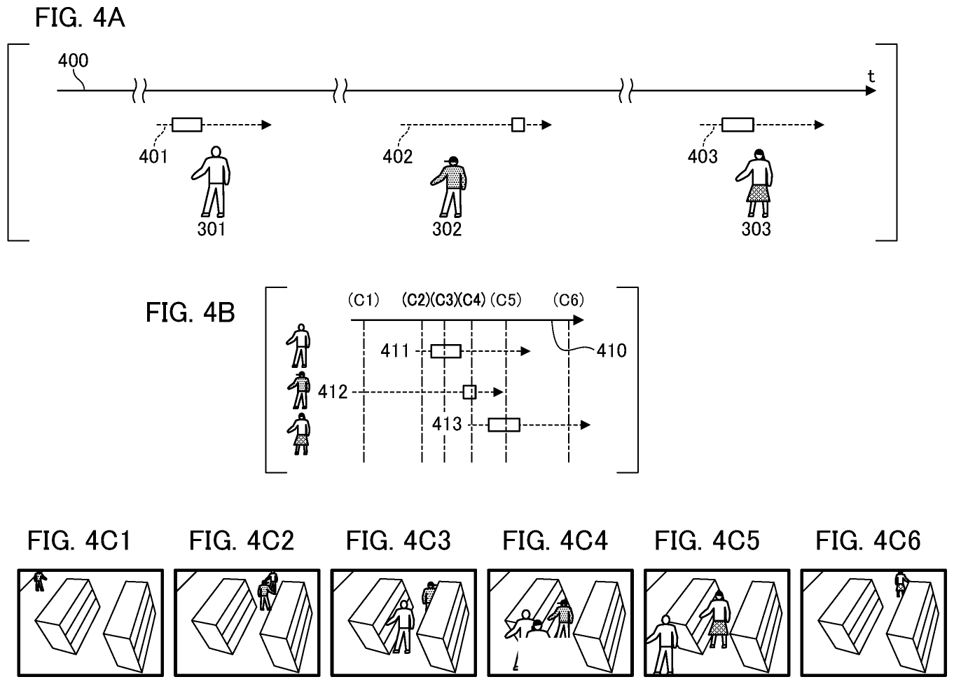

Next, the operation of the video image processing apparatus in the present embodiment will be explained with reference to FIGS. 3 and 4. FIGS. 3A, 3B, 3C, and 3D are schematic diagrams explaining examples of the movement of subjects in Embodiment 1.

FIGS, 4A. 4B, 4C1, 4C2, 4C3, 4C4, 4C5, and 4C6 are drawings that explain the method for creating a summary video image from a summary original video image in Embodiment 1. In this context, FIG. 4 explains an example in which a summary video image of a person who has reached their hand out for a designated shelf is generated from the video images from a camera located in a store.

FIG. 3A is a schematic diagram that illustrates an example of a video image captured by the image capturing unit 201. The image capturing unit 201 is located on the ceiling of a retail store in the area where a product shelf 300 is arranged, and captures images of the area below.

A case will be considered in which the user would like to check the people (subjects) who have performed the predetermined feature action of reaching out their hand to the product shelf 300 where a new product has been placed, in order to analyze the customer reaction to the new product. In this case, a summary video image is created using the present embodiment from the video image recordings (referred to below as the summary original video image) from, for example, 1 month, that have been captured by the image capturing unit 201 and recorded on the storage unit 209.

FIGS. 3B, 3C, and 3D are all schematic diagrams that illustrate examples of people who reached out their hand to the product shelf 300 and have been recorded in the summary original video image. In FIG. 3B, a person 301 moves along the path of the dotted arrow in the same figure and in the middle of doing so reaches their hand out for the product shelf 300. FIG. 3B is a schematic diagram of the moment that they reach their hand out. FIG. 3C and FIG. 3D are the same for person 302 and person 303, respectively.

The appearance times in the summary original video image for the person 301, the person 302, and the person 303 are separated by several days or several weeks, and manually searching for these people and performing comparison while playing back from a long video image is extremely troublesome for a user and requires time and effort.

A specific example of a summarized video image with these three people, who are included in the summary original video image, as subjects will be explained below.

Note that although the explanation will be given using an example with a small number of people for illustrative and explanatory purposes, it is also possible to create the same summary video image using a larger number of people as targets, for example, several dozen to several hundred people, and in that case, it is anticipated that the usefulness will further increase. Note that rather than a plurality of subjects, the user may also select a plurality of time periods in which a single subject performs a predetermined movement, and the summary video image may be synthesized by bringing the video images of the plurality of time periods that have been selected closer together in time.

For example, in the case in which a video image is generated from a long video image (for example, 1 year), it is possible that the same person will be captured many times. A video image may also be synthesized that the actions that the user would like to focus on are extracted from among the actions performed by the same person, such as actions that occur with a statistically high or low frequency, those that occur in a predetermined location, or the like. Using the processing that will be explained below, it is also possible to synthesize a video image in which, for example, the feature actions that have been performed by the same person at different times are superimposed simultaneously.

FIG. 4A is a timeline drawing illustrating the appearance times of the people who are included in the summary original video image, in which the passage of time is shown moving from left to right. The arrow 400 illustrates the total temporal range of the summary original video image, and the appearance times of the people 301, 301, and 303 are illustrated by the dotted arrows 401, 402, and 403, respectively.

The superimposed rectangles in 401, 402, and 403 illustrate the time ranges in which the people performed the focused action from among their appearance times, in this context, the time range in which they reached their hand out for the product shelf 300. Note that although some parts of the arrow 400, which illustrates the length of the summary original video image, are omitted for convenience's sake, the total length is much longer than the appearance times of the people.

FIG. 4B is a drawing that explains an example of a video image that summarizes the summary original video image that is illustrated on the timeline in FIG. 4A using the present embodiment.

The arrow 410 illustrates the entirety of the summarized video image. 411, 412, and 413 each represent the appearance times of each of the people 301, 302, and 303 in the summarized video image. The length and the time periods of the focused actions for 411, 412, and 413 are each the same as those of 401, 402, and 403 in FIG. 4A.

By synthetically distributing the video images of a plurality of time periods by bringing them closer together in time as illustrated in the diagram, all of the people who appear at different times in the summary original video image are displayed at the same time in the summarized video image, while still being displayed in the correct order within the scope of when they performed the focused action, without overlapping. As a result, a video image in which the people visit and reach their hands out for the product shelf 300 one after another is synthesized as the summarized video image.

FIG. 4C1, 4C2, 4C3, 4C4, 4C5, and 4C6 are schematic diagrams of representative frames of the summary video images illustrated in FIG. 4B. Each of them illustrates each of the time frame images that are shown as alternate long and short dotted lines in FIG. 4B. In FIG. 4C, FIG. 4C3, FIG. 4C4, and FIG. 4C5 are the frame images of the times in which each of the people 301, 302, and 303 are reaching out their hand for the product shelf 300.

For example, in FIG. 4C4, the person 302 is reaching out their hand for the product shelf 300, however, the person 301, who is moving away from the product shelf after having reached their hand out for it, and the person 303, who is moving towards the product shelf, are shown at the same time.

By creating this kind of summary video image, the movements of the people from before and after are continuously displayed while focusing on the exact moment that someone reaches their hand out for the product shelf 300, and therefore, the user is able to obtain a summary video image that can be easily and effectively checked in a short period of time.

In this context, in order to perform the synthesis of a summary video image by prioritizing the action that is being focused on, the order of appearance of the people does not necessarily have to match that of the summary original video image. For example, in CA, in the summary original video image, the person 302 appears after the person 301. However, in the summarized video image, the person 302 appears in FIG. 4C1, and then after that the person 301 appears in FIG. 4C2.

This is based on the length of their residence time before the person 302 reaches their hand out for the product shelf 300. In addition, although the summary video image is controlled so that the subjects do not overlap each other in order to make the moment of the focused action easily confirmed, there also are cases in which as a result, people overlap at times other than when the focused action was performed. In the example in this figure, the person 301 and the person 303 overlap in FIG. 4C2 and in FIG. 4C4.

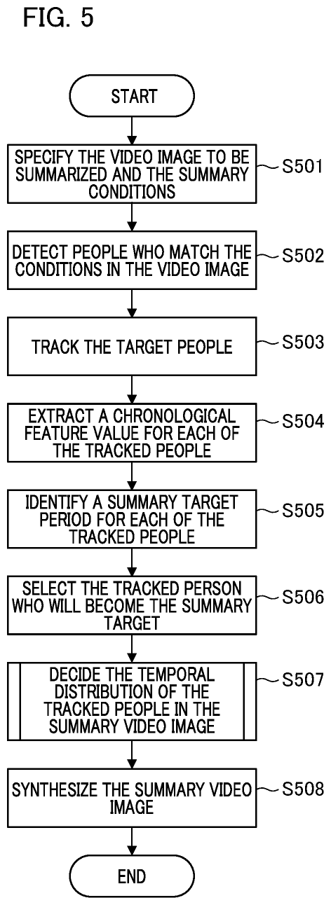

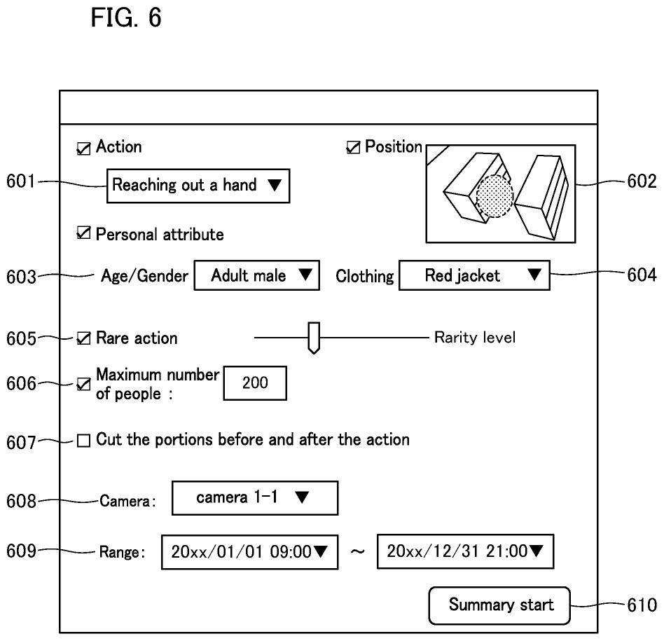

Next, FIG. 5 is a flow chart that illustrates the order of processing in Embodiment 1, and FIG. 6 is a drawing that illustrates an example of the settings screen displayed by the display unit 210 in Embodiment 1. An example of the operational flow and settings screen that are used in order to make the above operations possible will be explained with reference to FIGS. 5 and 6. Note that, the flow in FIG. 5 is performed when the MPU 207 of the analysis server 102 executes the program that has been stored on the memory 208.

First, in step S501, using the client terminal apparatus 104, the user receives information regarding the summary conditions and the specifications for the summary video image.

FIG. 6 is a schematic diagram that illustrates an example of the summary conditions settings screen that is displayed on the display unit 210 of the client terminal apparatus 104. The user operates the controller unit 211 and sets their desired summary conditions.

The display control of the UI (User Interface) in FIG. 6 is performed by the MPU 212 of the client terminal apparatus 104 executing the program that has been stored on the memory 212.

601 is a pulldown control for the user to specify the contents of the action of the person that they would like to make the target of the summary. The period selection unit 203 prepares in advance a plurality of types of recognizable actions as the selectable actions and lists therm. The user then selects one or more action. In this context, the user can specify the feature movement of the subject using 601.

602 is a control for the user to specify the region that they would like to make the target of the summary from among the occurrence positions of the movement of the person that has been specified in the pulldown 601. The user specifies the detection range of the action of the person that they would like to make the target of the summary by filling in the displayed background screen at the time that the action specified in the pulldown 601 was performed.

In the example in FIG. 6, in order to illustrate the shelf for which the reaching out a hand is to be detected, the region that is illustrated with half-tone dot meshing is filled in. In this case, if a person performs the action of reaching out their hand, or if that person's hand enters the region that is illustrated with half-tone dot meshing, they will become a target of the summary. Note that, in order to specify the region, the region may be specified by, for example, circling the desired region with a mouse or the like.

Note that the region specification method may be changed according to the type of action. For example, if the target action is “suddenly started to am”, the region at the subject's feet when they start to run is specified, or if “falling over” is the target action, the region that includes the lowest part of the person's body, regardless of which body part it is, is specified. In addition, the specified action may be made into the summary target by specifying the region as the entire video image, or anywhere on the screen.

603 is a pulldown control for specifying the personal attribute regarding the age and gender of the person that the user would like to make the target of the summary (the attribute of the subject). In addition, 604 is a pulldown control for specifying the clothing of the person that the user would like to make the target.

The detection unit 202 prepares a plurality of these detectable personal attribute (types) as options and lists them. The user then specifies one or more of each. In this way, 603, 604, and the like function as a specifying unit for specifying the attribute of the subject.

605 is a slide bar for specifying the threshold of the degree of rareness in a case in which the user would like to make a person who has performed a “rare” action, for which the frequency of occurrence is low, the target of the summary. The user specifies, for example, a “rarity level” that has been standardized from 0 to 100. This is used when the user would like to focus not on an explicitly specified action, but instead on a person who was performed an action that has a low frequency of occurrence.

606 is a numerical value input control for limiting the number of people that will be displayed in the summarized video image.

607 is a check box for instructing the cutting of the portions before and after which are not the summary target actions. In the example in FIG. 4 it is indicated that the portions that correspond to FIG. 4C1, and FIG. 4C2, which occur before the summary target action is performed, and FIG. 4C6, which occurs after, are removed from the summarized video image, in order to shorten the length.

Each of the controls from 601 to 607 are provided with a check box, and can be switched to valid (enabled) or invalid (disabled). The user can validate the controls and combine conditions according to necessity in order to express their desired summary conditions.

608 is a pulldown control for selecting one network camera, for example network camera 101, in a case in which a plurality of network cameras exist.

Note that, 608 may be made so as to select the recorded video image of a specified camera that has been recorded on the recording server 103 and the like, and the video image processing apparatus may carry out a video summary on a video image file that has been provided from a network or storage media, without having an image capturing unit. Or, 608 may be made so as to select a live video image from a predetermined camera. 609 is a start time and end time input control for specifying a time frame. The summary original video image is determined by the information from 608 and 609.

The user operates the above controls by using the controller unit 211, and once they have finished specifying their desired summary conditions, presses the summary start button 610. When the summary start button 610 is pressed, this information is received in step S501, and the flow proceeds to step S502.

In step S502, the detection unit 202 acquires the summary original video image that has been specified in step S501 from the live video image from a camera or from the storage unit 209, and detects a person who matches the conditions that have been specified in step S501 from the summary original video image. That is, it detects a subject having the predetermined attribute.

The detection unit 202 determines the time and position at which the person who is the target appears in the video image using, for example, a publicly known object recognition technology such as the one that is disclosed in non-patent publication 1. In this context, in step S501, “adult male” has been specified in the pulldown 603, and “red jacket” has been specified in the pulldown 604.

That is, objects that have high scores for the general object recognition categories “male”, “adult”, “jacket”, and “red clothing” will be made the targeted people. (Non-patent publication 1: Ren, Shaoqing, et al. “Faster R-CNN: Towards real-time object detection with region proposal networks.” Advances in neural information processing systems. 2015.)

Next, in step S503, the detection unit 202 performs tracking of the people detected in step S502 and who are included in the summary original video image. That is, it tracks the temporal changes in positions of the people who appear consecutively in the summary original video image. That is, the detection unit 202 performs tracking of the detected bodies using a publicly known technique such as the one that is disclosed in non-patent publication 2, and, in the case that the number of detected people is n people, the information for each person (human information) is H₁, H₂ . . . , Hₙ.

In this context, step S503 functions as a tracking unit that detects subjects that have predetermined attribute by tracking them. (Non-patent publication 2: H. Grabner, M. Grabner, & H. Bischof: Real-time tracking via online boosting. In BMVC, 2006.)

The human information Hᵢ (1≤i≤n) comprises the tracking start time Bᵢ of the person, the length of time Lᵢ until the tracking end time, and the position and size Hᵢ (t) in the video image of the person in Time t∈[Bᵢ, Bᵢ+Lᵢ]. In this context, Hᵢ (t) is the sequence of circumscription rectangles in the coordinates of the frame screen, which have been separately preserved in time t, of the video image frames that are included in the time range [Bᵢ, Bᵢ+Lᵢ] of the summary original video image.

Note that this expression of the tracked person is one example, and a mask screen or the like that illustrates a body region as Hᵢ (t) may also be used, and Hᵢ (t) may be established as a continuous function of time t rather than a discrete sequence.

Next, in step S504, the period selection unit 203 will extract a feature amount that will temporally change for each of the human information H₁, H₂, . . . , Hₙ that was created in step S503. In this context, the feature amount is an estimation of the information about the person's joint position and pose. The human information Hᵢ is a feature amount that is an estimation of each of the peoples' poses for the time t of the frame images that are included in the time range [Bᵢ, Bᵢ+Lᵢ], and for the portion of the video image that has been cut from the rectangle of Hᵢ (t), using a publicly known technology such as the one disclosed in non-patent publication 3.

In this context, step S504 functions as a feature amount extraction unit that extracts a feature value that changes temporally from a video image. (Non-patent publication 3: Wei, Shih-en, et al., “Convolutional pose machines.” Proceedings of the IEEE Conference on Computer Vision and Pattern Recognition. 2016)

Next, in step S505, the period selection unit 203 will select the summary target periods for each of the human information H₁, H₂, . . . , Hₙ, based on the feature value that was extracted in step S504. In this context, in Step S501, the processing that identifies the period of the human information Hᵢ will be explained using an example in which the action of “reaching out a hand” has been selected from the pulldown 601, and in which C has been specified as the value for the rarity level after 605, has been validated.

First, in order to identify the periods for the action of reaching out a hand for the human information Hᵢ, the coordinates of the subject's right hand and left hand in the video image are acquired from the feature value in the Hᵢ (t) for the frame time t∈[Bᵢ, Bᵢ+Lᵢ], and whether or not any are included in the region that was specified in 602 is identified. A series of results with 1 if it is included, and 0 if it is not included, is created, and smoothing is performed for the majority decision based on, for example, the frame itself and each of the 5 frames before and after it. As a result of this smoothing, for example, time ranges in which 1 continuously occurs ten times are each identified as “periods in which a hand was reached out”.

Note that the present embodiment is not limited to the feature movement of a hand reaching out, and the above is only an example. For example, if the action is “sits down”, it may be identified by the shape of the legs of the pose, regardless of the spatial position, or if the feature movement is “enters a restricted area”, it may be identified based simply on whether or not a person's position is in a specified range or not.

In addition, if the action is “in pain”, whether or not the person has a pained expression may be identified using a publicly known facial recognition method. Or, in a case in which the feature movement is a movement such as a golf swing or the like, whether or not the person is holding a golf club (whether or not one is currently being held) may be used as a portion of the judgement of the feature movement. That is, the feature movement may be distinguished based on an object held by the subject.

If the feature movement is “forgot an umbrella”, using the results of the general outline of object recognition, the state of the held object is identified based on the objects that appear in the vicinity of the person, and the period after they transition from the state of holding an umbrella, to the state of not holding an umbrella can be judged as the period in which they forgot the umbrella. In this way, the user can select the identification method having an ideal period according to the action that they would like to focus on.

Next, the period of a rare action will be identified. The detection of a rare action uses a publicly known method such as the identification of the degree of divergence of the feature movement from a normal action using locality sensitive hashing (LSH), such as, for example, that disclosed in non-patent publication 4. In LSH, a score based on the hashing distance is obtained, and in the case that it exceeds the threshold, it is identified as a rare action, and in the case that it does not, it is identified as a normal action. (Non-patent publication 4: ZHANG, Ying, et al. Video anomaly detection based on locality sensitive hashing filters, Pattern Recognition, 2016, 59: 302-311.)

Actions become more difficult to detect as the threshold becomes higher, that is, the search will be narrowed down and actions with a high “rarity level” will be detected, and therefore, when the rarity level value C, which has been specified in 605, is high, the threshold becomes high as well.

For example, the highest value C0 for a normal action score, and the highest value C1 for a rare action score of are statistically obtained and stored in advance.

Next, after setting C0+(C1−C0)×C/100 as the LSH threshold, whether a frame time t∈[Bᵢ, Bᵢ+Lᵢ] is normal or rare is identified based on the feature amount in Hᵢ (t). The sequence of the results of a rare action as 1, and a normal action as 0 is created, and the “period when the rare action was performed” is identified by performing smoothing in the same manner as for the action of reaching out a hand.

The entirety of the “periods when a hand was reached out” and “the periods when a rare action was performed” that have been identified in this way are determined as the summary target periods for the human information Hᵢ.

Note that, the method that has been explained in this context is one example, and, for example, the smoothing and related identification parameters may be different values, and, for example, may be made to change based on the FPS of the summary original video image and the like. In addition, instead of the binary sequence of 0 and 1 for the sequence of the results, a real number value that has been obtained from the score or the like may be taken, and the successive periods may be obtained using thresholds and maximums.

In addition, the identification of the action of reaching out a hand does not need to be identified based on the position of the hands in the video, for example, the interaction between the product shelf and the hand may be identified 3-dimensionally using a distance image. In addition, the identification method for a rare action is not limited to LSH, and other methods such as the Bayes Decision Rule, or a neural network and the like may be used.

in addition, as explained in step S505, the present embodiment is not limited to the action of reaching out a hand, and can obtain the periods when an action was performed in the same way for other actions. The only requirement is, in step S505, being able to identify that a subject performed the feature movement that was specified in advance in 601 and 605.

Next, in step S506, the summarizing unit 204 will select a person based on the summary target period that was judged in step S505. The people for whom one or more summary target periods were identified in step S505 will be selected from among the human information H₁, H₂, . . . , Hₙ, and made the summa targets. The human information that has been selected as the summary targets will be made H′₁, H′₂, . . . , H′ₘ.

In step S501, in the case that, for example, 200 people is specified as the maximum number of people for the summary video image in the numerical value entry control 606, m will be selected so as to be less than 200. If the number of people in the summary original video image for whom summary target periods are identified is greater than 200 people, for example, 200 people will be selected and made H′₁, H′₂, . . . , H′ₘ from among those who have summary target periods with long lengths. They may also be selected based on their feature amount or their rare action score.

Next, in step S507, the distributing unit 205 will determine the distribution of the human information H′₁, H′₂, . . . , H′ₘ for the summary targets that have been selected in step S506. Specifically, the appearance start times T₁, T₂, . . . Tₘ of each person will be determined, and it will be made so that the human information H′ᵢ appears T₁ seconds from the start of the summary video image. The determination method for T₁, T₂, . . . Tₘ will be explained below.

Next, in step S508, the video image synthesizing unit 206 will synthesize the summary video image based on the distributions that have been determined in step S507. First, one time frame image in which no people appear in the summary original video image will be selected and made the background image, and the sequence of frame images will be created by copying the background image.

With respect to the human information Hᵢ, publicly known methods such as background subtraction or region segmentation and the like are used to cut people and regions from each frame of the time range [Bᵢ, Bᵢ+Lᵢ] in which the human information Hᵢ from the summary original video image appears, and the other portions generate a sequence of transparent cut images.

Additionally, the cut-out images of the human information Hᵢ will be superimposed in order, starting from the frames of the background image sequence that occur after only Tᵢ from the start. This will be performed for each of the human information H′₁, H′₂, . . . Hₘ. However, the cut-out images of people for the frames pertaining to the summary target periods for certain people will be superimposed last. This is done so as to prevent the person's actions from the summary target period being hidden.

Once the superimposition is complete, next, in the case that the check box 607 was checked in step S501, the frames other than those for the targeted action will be deleted. That is, from among the sequence of frame images, counting from the first to the last, portions with continuous frames in which not a single frame that corresponds to a summary target period of a person has been superimposed, will be deleted.

The visibility is improved by deleting unnecessary video images.

Finally, the summary video image will be created by encoding the frame video images using video formats such as MPEG4/H246 and the like, and the flow will end after recording the summary video image on the storage unit 209.

The user can view the summary video image that has been recorded on the storage unit 209 using the client terminal apparatus 104 after the present flow has finished.

Note that, the frame video images may be transmitted by streaming during step S508 so that the user can first view the video images before the encoding has finished. In addition, instead of a cut-out video image, a schematic image that illustrates the feature value, for example a skeletal diagram that connects the joints with straight lines, or illustrations of a human figure or an avatar may also be used.

In addition, the method of superimposing the people from the summary target periods last is explained as a method to prevent these images from being hidden, however, another method may be used. One example is the method of making cut-out images of the people into drawings in a semi-transparent state by adding an alpha chain to them, and then making the alpha chain for the people from the summary target periods zero or a relatively low value.

As a further method, there is also the method of making only the people from the summary target periods cut-out images, and making the other overlapping people drawings, as, for example, skeletal diagrams. All of these methods make it so that the people from the summary target periods are easily visible, while also making it possible to partially see the information for the other, overlapping people, and have the effect of increasing the information that is provided to the user.

Using the above processing, a summary video image that is ideal based on the object of the user and that has good visibility can be provided for the periods on which the user would like to focus. Note that, in the present flow, analysis is performed after the user has specified a video image. However, the processing may also be made to execute analysis in the background at the time of recording of a live image and to record the results on the storage unit 209, then reference the results that have been saved when the summary target is synthesized.

The processing may be separated so that a portion of the time-consuming processing is performed in the background, and the lightweight processing as well as the normally used processing concerning low frequency conditions are performed when specifications are received from the user. In addition, rather than performing all of the analysis processing on the analysis server 102, a portion or all of the analysis processing may be delegated to an external computer such as a cloud.

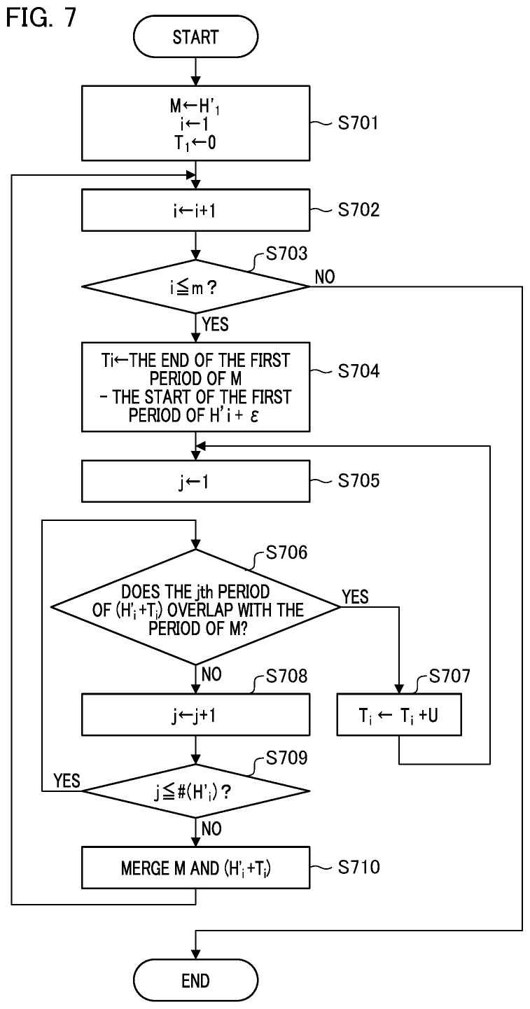

FIG. 7 is a flowchart illustrating a detailed example of the order of processing that occurs in step S507 in Embodiment 1, and the method for establishing T₁, T₂, . . . , Tₘ used by the distributing unit 205 in step S507 will be explained with reference to FIG. 7. First, in step S701, an operational period sequence M is prepared, and the summary target period for H′₁ is copied. In addition, the value of i is made 1, and the value of T₁ is made 0.

Next, in step S702, 1 is added to i, and then in step S703, whether or not i is equal to or less than m is identified. m is the number of people that was selected by the summarizing unit 204 in step S506. If i is equal to or less than m, the flow proceeds to step S704. If i is larger than m, the entirety of T₁, T₂, . . . , Tₘ will already have been determined by the processing of step S704 and after, and therefore, after making this the result of step S507, the present flow will end.

In step S704, the value for Tᵢ is established as the value that is the result of a buffer ε being added to the difference between the ending point of the earliest chronological period that is included in M and the time of the starting point of the first period of H′ᵢ. The buffer ε is a buffer that is provided between the summary target periods that continuously appear in the summary video image. The buffer ε can be 0, and if the start and end of the summary target periods are permitted to overlap, it can also be made a negative value. However, in this context, as an example, the buffer ε will be explained as a positive value that has been established in advance, for example, 0.3 seconds, or the like.

In preparation for the explanation of the following steps, suppose that the entirety of the summary target periods for H′ᵢ that has been advanced only by time t will be expressed as (H′ᵢ+T).

After step S704, the flow proceeds to step S705, and the value of j is established as 1.

Next, in step S706, first the j^{th} period S of (H′ᵢ+Tᵢ) is acquired. Then, whether or not S overlaps with any of the periods included in M will be identified, taking the buffer into consideration. That is, when identifying an overlap with S, the starting times and ending times of each of the periods that are included in M are those that have been extended by only the buffer ε.

Even in a case in which the range of overlap with S is limited to only the portion that has been extended by the buffer, it will simply be identified as overlapping. Based on the above identification, in the case that there are periods of M that overlap with S, the flow will proceed to step S707. In addition, from among such periods of M, the one that is chronologically first will be made SM. If S does not overlap with any of the periods of M, the flow will proceed to step S707.

In step S707, first, the difference in time between the end of SM and the beginning of S will be calculated with the addition of the buffer ε and made U. Then, a new Tᵢ value will be made by adding Tᵢ to U. The flow will then return to step S705.

In step S708, 1 is added to j. Then, next, in step S709, whether or not j is less than the number of summary target periods, # (H′ᵢ), that are included in H′ᵢ is identified, and if it is, the flow will return to step S706. If j is larger than # (H′ᵢ), the flow will proceed to step S710.

The case in which the flow has proceeded to step S710, is, in other words, a case in which the entirety of the periods of (H′ᵢ+T) do not overlap with any of the periods of M (even taking the buffer into consideration). The value of Tᵢ is determined in this context.

In step S710, a new M is made by merging M with (H′ᵢ+Tᵢ). That is, copies of the entirety of the periods of (H′ᵢ+Tᵢ) are added to M. Then the flow returns to step S702.

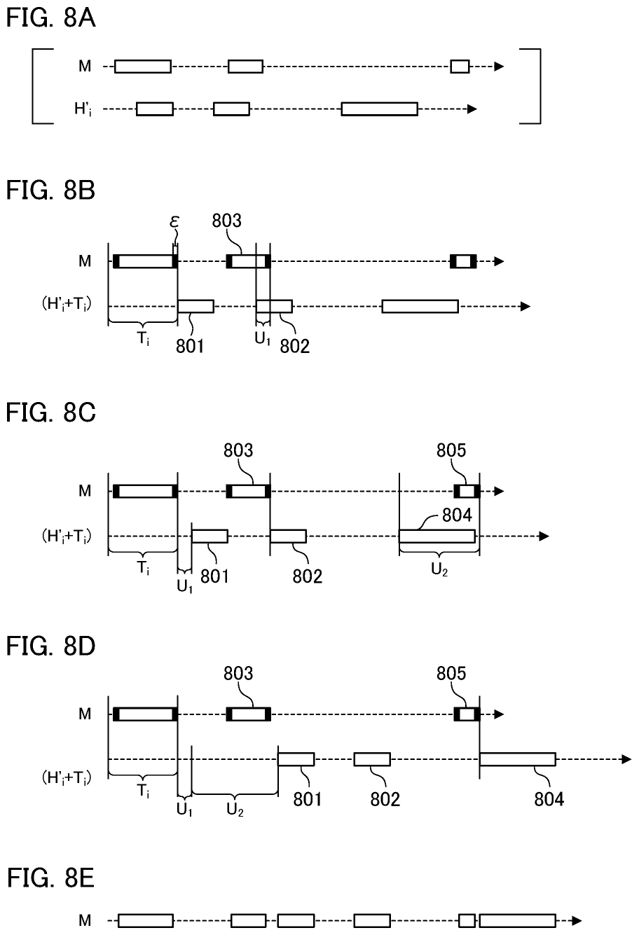

FIGS. 8A, 8B, 8C, 8D, 8E are drawings that explain the changes made to the period sequence M in the processing of step S507 in Embodiment 1. FIG. 8A is an example of M and H′ᵢ directly before step S704. How they change according to the flow of FIG. 7 will now be explained.

FIG. 8B illustrates M and (H′ᵢ+Tᵢ) when the flow has proceeded to steps S704 and S705. The black strip before and after the periods of M illustrate the buffer having the length_{ε}. When the value of Tᵢ is established by the method in step S704, the start of the first period of (H′ᵢ+Tᵢ) matches the time of the end of the first period of M that has had a buffer added to it.

In step S706, the period 801, which is S when j=1 does not overlap with any of M, and therefore the identification becomes NO, the flow proceeds to step S708 and step S709, and the flow returns to step S706 when j=2. In step S706, the period 802, which is S when j=2, overlaps with the period 803 of M, and therefore, the identification becomes YES, and the flow proceeds to step S707.

The U that has been calculated in step S707 (referred to as U₁ in the explanation below) is as illustrated, and is the result of ε being added to the difference between the start of the period 802 and the end of the period 803 (SM).

FIG. 8C illustrates an example when U₁ has been added to Tᵢ in step S707. The new period 802 of (H′ᵢ+Tᵢ) is moved to directly after the position where the buffer has been added to the period 803 of M by increasing Tᵢ by only U₁.

Consequently, the other periods of (H′ᵢ+Tᵢ) proceed forward with only U₁. At this time, when j=1 and j=2, the identification in step S706 becomes NO. However, this time, the period 804 overlaps with the period 805 of M when j=3, and the identification in step S706 becomes YES, and the flow proceeds to step S707. In step S707, U is calculated again with period 804 as S, and period 805 as SM (this U will be called U₂).

FIG. 8D illustrates an example when U₂ has been added to Tᵢ in step S707. The new period 804 of (H′ᵢ+Tᵢ) is moved to directly after the position where the buffer has been added to the period 805 of M, and the other periods of (H′ᵢ+Tᵢ) also proceed forward only by U₂.

Now, because there are no longer any periods in which M and (H′ᵢ+Tᵢ) overlap, the identifications in step S706 for all of j=1, j=2, and j=3 become NO, and the flow proceeds to step S710. FIG. 8E is the new M, which has been merged with H′ᵢ in step S710. It is important to note that there are no longer any overlapping periods and that a buffer of a length_{ε} or greater has been secured between each period.

In this way, in accordance with the flow of FIG. 7, the appearance order in the first summary target period is preserved and a buffer can be secured for the summary target periods under the condition that the summary target periods of the human information H′₁, H′₂, . . . , H′ₘ do not overlap. Based on this, continuously appearing positions can be determined.

As explained above, the summary video image is synthesized by using the T₁, T₂, . . . Tₘ of the distribution that has been obtained in accordance with the flow of FIG. 7. Note that, the present flow is an example, and other distribution searching methods may be used according to the user's object. For example, if the user does not need to preserve the appearance order, and wants the summary video image to be as short as possible, the shortest overlapping H′₁, H′₂, . . . , H′ₘ may be chosen by searching using all possible combinations.

In addition, if the action is of a low frequency such that one person would not be expected to perform it multiple times, the summary target periods may be simplified, for example by simply lining them up, assuming that there is one summary target period for each person. Using the processing that has been explained above, a summary video image with good visibility can be generated. It is also expected that such a summary video image, which has good visibility, can be used for effective analysis in security and marketing.

### Embodiment 2

In Embodiment 1, a method for synthesizing a summary video image with the object of being able to continuously monitor the periods of an action that the user would like to focus on was explained. However, there are cases in which a summary video image that simultaneously displays the movements that the user wants to focus on would be useful such as one in which the user wants to perform a comparison of movements. In Embodiment 2, a method for synthesizing a summary video image with good visibility that prevents overlapping while also simultaneously displaying the periods of the focused movements as far as possible will be explained.

That is, in the present embodiment, the above distributions will be determined in such a way that the video images from a plurality of time periods do not temporally or spatially overlap.

Note that, in this context, portions that have been added to or changed from Embodiment 1 will be explained, and explanations of their shared properties will be omitted.

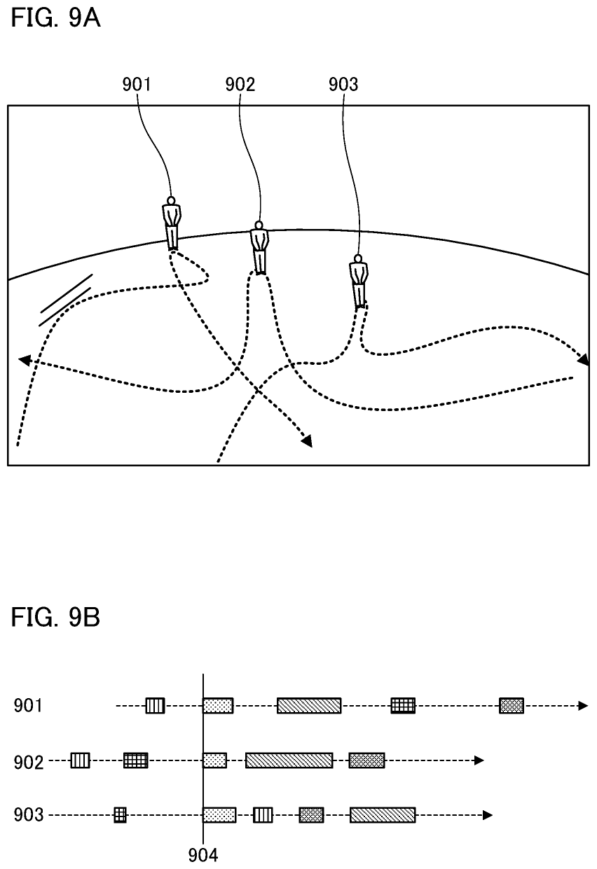

FIGS. 9A and 9B are drawings that illustrate examples of a summary video image in Embodiment 2 of the present invention, and an example of an operation of the video image processing apparatus in the present embodiment will be explained with reference to FIG. 9. FIG. 9A is a schematic diagram that explains the contents of a summary video image in the present embodiment. In this context, an example of the practical application of lining up and displaying the timings at which figure skating competitors performed jumps and comparing the execution of the competitors' jumps will be explained.

The subjects 901, 902, and 903 in FIG. 9A each perform in front of the camera of the image capturing unit 201 at different times, and move along the paths illustrated by the dotted lines. The user would like to compare the jumps of the different subjects in order to evaluate the aesthetics of a specific type of jump that is specified in the program, for example an axel jump. In order to do so, a summary video image in which the timings at which the jumps were performed are lined up is created using the present embodiment.

FIG. 9B is the timeline of this summary video image, and FIG. 9A illustrates the states of the subjects 901, 902, and 903 at the timing 904. In the present embodiment, the focused periods have labels attached to them, and the summary video image is synthesized in such a way that at the timing 904, the beginning portion of the focused periods that have been labeled “axel jump” line up.

Other labels, such as “jump combination”, “step sequence” and the like that are specified movements of the program, are also added, and the user can evaluate while comparing each specified movement by lining up the subjects while choosing a label.

An operational flow of the video image processing apparatus of the present embodiment for synthesizing a summary video image such as the one described above will be explained. The flow is fundamentally the same as the process of FIG. 5, which was explained in Embodiment 1. However, the differences due to the attribute of the present embodiment will be explained.

In step S501 of the present embodiment, the user indicates the action that will be the summary target. However, the processing will be made so that the user indicates the movement in the form of a set of movements, for example the “axel jump” of a “figure skating short program”, as well as the movement classifications included in that set. The client terminal apparatus 104 displays a control for selecting the movement set and the movement classification, and the user makes commands by operating this.

In step S505 of the present embodiment, the period selection unit 203 first selects each of the periods for the movement classifications that are included in the movement set that has been indicated in step S501, and adds the corresponding movement classification label to the period information.

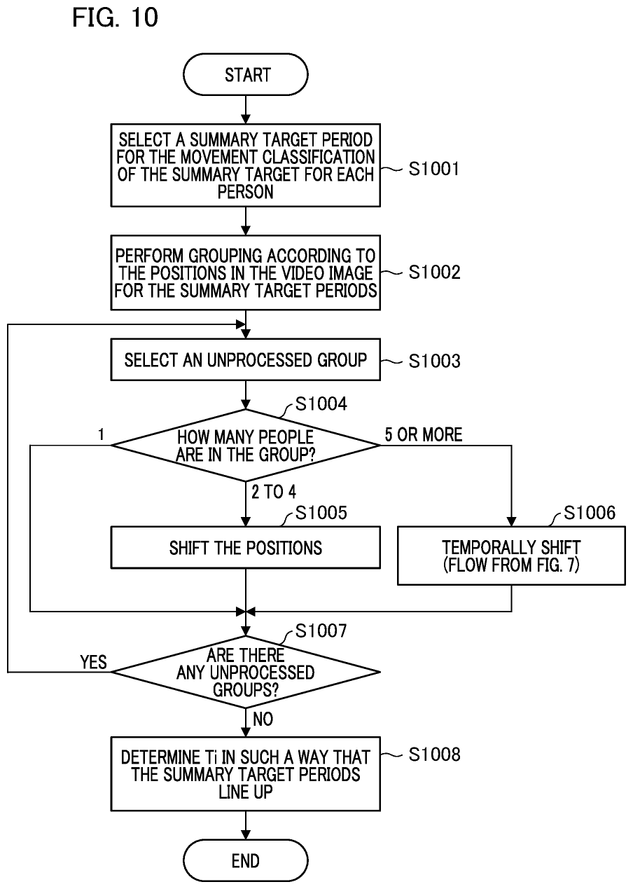

FIG. 10 is a flowchart that illustrates an example of the processing in step S507 in Embodiment 2, and step S507 of the present embodiment will be described below.

First, in step S1001, the summary target periods that correspond to the movement classification of the summary targets that have been indicated in step S501 will be selected, based on the labels, for each person from the summary targets that have been selected in step S506. The following processing is performed on the selected summary target periods.

Next, in step S1002, the positions of the people in the summary original video image are calculated for each of the summary target people in the summary target periods that have been selected in step S1001, and the grouping of the summary target people is performed based on these positions. Specifically, the average position is calculated for each person focusing on the circumscription rectangles of the people in the frame corresponding to the summary target period, and the groups are created using a method such as one in which people who are at a distance closer than a predetermined threshold are collected in the same group.

Below, steps S1003 through S1007 will be performed for each of the groups that have been created in step S1002. First, in step S1003, one group for which processing has not yet been performed will be selected.

Next, in step S1004, the number of people in the summary targets that are included in the group that has been selected in step S1003 will be identified. If there is only one person, the flow will proceed to step S1007 without doing anything. However, if there are between two and four people, the flow will proceed to step S1005, and if there are five or more people the flow will proceed to step S1006, and then each step will then proceed to step S1007.

In Step S1005, the parallel displacement parameters for each of the people in the summary target included in the group that has been selected in step S1003 will be obtained so as to avoid overlapping.

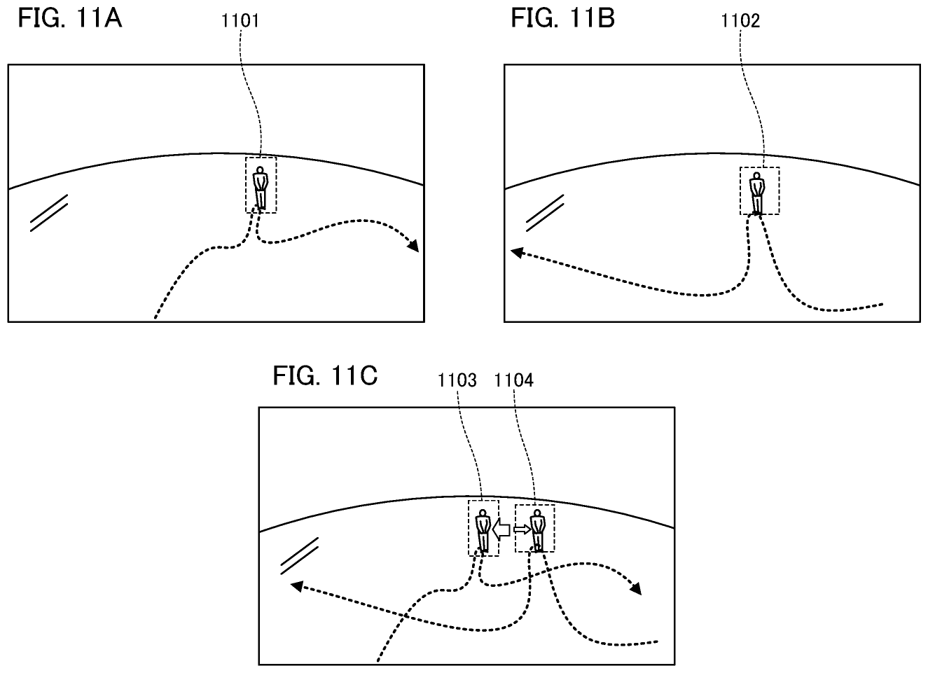

FIGS. 11A, 11B, and 11C are drawings that explain the processing in step S1005 in Embodiment 2, and FIG. 11A and FIG. 11B are schematic diagrams that illustrate the summary target people belonging to the same group.

The rectangles 1101 and 1102 illustrate the range in which the people's circumscription rectangles move in the summary target period that has been labeled “axel jump” for each of the people in FIG. 11A and FIG. 11B.

The people in FIG. 11A and FIG. 11B perform the same movement of an “axel jump” in positions that are spatially adjacent, and therefore, if they are summarized like this by lining up the “axel jumps”, they will overlap in the summary video image, and the visibility will be hindered.

Due to this, as shown in FIG. 11C, the purpose of the present step is to prevent overlapping by parallelly displacing each person in diverging directions. The rectangles 1103 and 1104 are the ranges of movement for the circumscription rectangles after parallel displacement for each person in FIG. 11A and FIG. 11B, and the arrow that is displayed illustrates the displacement vector. Subsequently, the video image synthesizing unit 206 synthesizes the summary video image using the displacement vector that has been determined in this context.

In step S1006, processing is performed according to the flow illustrated in FIG. 7 with the people who are included in the group that has been selected serving as the target. That is, it is the same as step S507 in Embodiment 1, and uses a method that prevents the overlapping of summary target periods by shifting them temporally.

Step S1006 is the processing for a case in which there are 5 or more people in a group, and is a method that is only executed in cases in which it is anticipated that resolving the overlapping using the parallel displacement method of step S5005 would be difficult because there are too many people.

In this case, rather than lining up the timings of the summary target periods, the intention is to make it so that those portions are displayed in order in the summary video image.

In Step S1007, whether or not any groups still remain for which processing has not yet been performed after the processing of step S1005 or S1006 has been performed, or after the processing after step S1004 was not performed because there was 1 person, is judged, and if any remains, the flow returns to step S1003. If processing has been performed for all of the groups, the process proceeds to step S1008.

In step S1008, the appearance start times T₁, T₂, . . . , Tₘ are determined in such a way that the summary target periods can be lined up. Specifically, from among the starting points of the summary target periods that have been selected in step S1001, the person's tracking start time and the time difference Dᵢ thereof are both calculated, and the largest one, Dmax, is chosen and established as Tᵢ=Dmax−Dᵢ.

However, in the case that there is a group that has gone through the flow illustrated in FIG. 7 in step S1006, the appearance start time will be obtained using the above method for only the person who has the first summary target period, and this will be made T_{b}. Then, it will be established as Tᵢ=T_{b}+T′ᵢ for the other people in the same group.

In this context, T′ᵢ is the appearance start time of the group that was obtained in step S1006. The flow ends with the above appearance start time serving as the result of step S506 in the present embodiment.

Note that, limiting the position shifting processing to up to four people is an example, and the number of corresponding people that are handled by moving their position may be increased after preventing overlap by increasing the movement amount or the like.

Conversely, if shifting the positions will have a negative effect, the processing can be made so that, rather than shifting the positions, the people are shifted temporally if they will overlap (everything will proceed to step S1006 if more than two people are identified in step S1004).

The processing may also be made so that this number of people is set by the user in step S501.

In step S508 of the present embodiment, the video synthesizing unit 206 synthesizes the summary video image using the displacement vectors that have been determined in step S1005, in addition to the appearance start times T₁, T₂, . . . , Tₘ as the distribution information that has been determined in step S507.

Superimposition is performed for the people to which displacement vectors have been applied after the entirety of the appearances have been parallelly displaced along the displacement vectors.

As described above, a summary video image can be created in which the timings of the movements on which the user wants to focus line up.

### Embodiment 3

In Embodiments 1 and 2, synthesis methods for summary video images in which people are used as the subjects, and in which the actions of people are focused on, were explained. However, the present embodiment can also be applied to subjects other than people.

In the present embodiment, a method that uses automobiles as subjects will be explained.

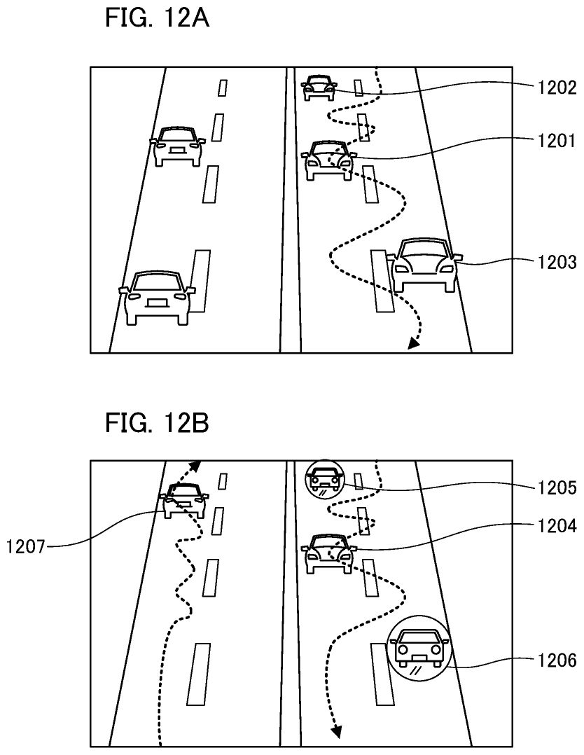

FIGS. 12A and 12B are drawings that explain summary video images in Embodiment 3 of the present invention, and FIG. 12A is a schematic diagram of one time period from a summary original video image in an example in which an automobile road is being captured by the image capturing unit 201. The present embodiment is used when the user is monitoring an automobile road, and they would like to check the summary video image in order to observe automobiles that exhibit reckless driving, for example swerving and using excessive speed as in 1201.

FIG. 12B is a schematic diagram that illustrates an example of the video image that summarizes from the summary original video image in FIG. 12A. In addition to displaying the automobile 1201 that exhibited the reckless driving in a summary video image like 1204, the automobiles 1202 and 1203, which appear in the vicinity of the reckless driving of the automobile 1201, are also displayed in the summary video image in order to evaluate the effect of the reckless driving on its surroundings.

However, because the automobiles 1202 and 1203 did not exhibit reckless driving and are not subject to penalties, taking their privacy into consideration, they are made to be displayed not as they appear in the summary original video image, but as illustrations like 1205 and 1206.

The illustrations 1205 and 1206 of the automobiles 1202 and 1203 have their positional relationships relative to the reckless driving automobile 1204 stored, and are synchronized at the same timing as in the summary original video image. Another automobile that exhibited reckless driving, automobile 1207, is simultaneously displayed on the opposite side of the road that does not overlap with the automobile 1204. That is, the distributions are determined in such a way that the video images for a plurality of time periods are temporally synchronized.

The operational flow of the video image processing apparatus of the present embodiment, which is for synthesizing a summary video image such as the one described above will now be described. The flow is fundamentally the same as the process of FIG. 5 that was explained in Embodiment 2. However, the differences due to the attribute of the present embodiment will be explained.

In step S502 of the present embodiment, the detection unit 202 detects automobiles instead of people as the general outline of object recognition category, and in step S503 of the present embodiment, tracking will be performed with an automobile as the target.

In step S504 of the present embodiment, the period selection unit 203 performs feature value extraction for the automobile that has been detected in step S503. Specifically, the feature value is made a vector value that is a quantification of the position, speed, acceleration, surge, as well as the illumination state of the headlights, taillights, break lights, or the blinkers, the presence/absence of a new driver mark, an elderly driver mark, or a disability mark, and the vehicle classification in the video image.

These attributes may be calculated using a publicly known object recognition method, or the results of the general outline of object recognition of the detection unit 202 may be used. In addition, the varieties of attribute that have been listed here are examples, and do not prevent the addition of information about other useful attribute.

In step S505 of the present embodiment, the period selection unit 203 identifies the periods of the summary targets for each of the automobiles that are tracking targets. In this context, a period in which an automobile has performed a “rare action” is made the period of the summary target using the method of identifying the divergence from a normal action that was explained in Embodiment 1. There are various patterns of reckless driving, which makes it difficult to create a prediction model, and therefore, a method is used that differentiates the actions of automobiles that appear on a day-to-day basis, such as normal driving in a straight line and changing lanes, or passing other automobiles, and the like.

Note that, it is of course also possible to use a method that directly identifies the actions of automobiles that is identical to the method in Embodiment 1, and for example, in cases in which the user wants to observe actions such as stopping in a specific position, suddenly accelerating or decelerating, or turning right in a location where right turns are prohibited, there are also cases in which it is preferable to directly identify those movements. In addition, both methods may also be combined.

In step S506 of the present embodiment, the summarizing unit 204 selects an automobile that will become the summary target, and in step S507 of the present embodiment, the distributing unit 205 determines the distribution of the automobiles. Excluding the point that this target is an automobile rather than a person, this is identical to Embodiment 2.

In step S506 of the present embodiment, the video image synthesizing unit 206 synthesizes the summary video image. At this time, when creating a video image of the summary target periods, in addition to the images of the automobiles that correspond to these summary target periods, superimposition on the background image is performed for the automobiles that appear in the vicinity after having generated an illustration as a privacy measure.

The illustration is created by a combination of image templates in which images reflect the vehicle classification, the illumination state of the various lights, and effect lines that illustrate a feeling of speed, and the like, based on the contents of the feature amounts that has been extracted in step S504, and enlargement or reduction is performed according to its position in the video image. The illustration is superimposed before the cut-out image of the target vehicle of the summary target period, and is made to be displayed further back than the automobile of the summary target period, which is the primary object of interest. That is, in the present embodiment, it is possible to change the superimposition methods for the video images of a plurality of time periods.

Note that, as the privacy protection method, the automobile may be represented as a 3D model instead of as an illustration synthesized from a template, or other representations such as character information, wire frames, and the like may be used. In addition, methods in which a gradation is placed over the license plate, or the entire vehicle is turned into a silhouette, or the like may also be applied after using a cut-out image.

In addition, for example, the degree of reckless driving may be judged as low using a method in which the degree of divergence from normal driving is relatively low, or the like, and privacy processing may be added for the car that is the summary target as well if its degree is low.

As explained above, a summary video image of the actions of an automobile, for example, reckless driving, can also be obtained by applying the present embodiment.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to this embodiment, a computer program realizing the function of the embodiments described above may be supplied to the detection apparatus or the lithography apparatus through a network or various storage media. Then, a computer (or a CPU, an MPU, or the like) of the detection apparatus or the lithography apparatus may be configured to read and execute the program. In such a case, the program and the storage medium storing the program configure the present invention.

This application claims the benefit of Japanese Patent Application No. 2020-173769 filed on Oct. 15, 2020, which is hereby incorporated by reference herein in its entirety.

What is claimed is:

1. A video image processing apparatus having at least one processor or circuit configured to function as:
a video image acquisition unit configured to acquire video images;
a period selection unit configured to select, from the video images that have been acquired by the video image acquisition unit, a plurality of time periods in which a predetermined subject has performed a predetermined movement; and
a synthesizing unit configured to synthesize the video images from the plurality of time periods that have been selected by the period selection unit by bringing them closer together in time.

2. The video image processing apparatus according to claim 1, wherein the period selection unit selects, from the video images that have been acquired by the video image acquisition unit, time periods in which the predetermined movement has been performed by each of a plurality of subjects having predetermined attribute.

3. The video image processing apparatus according to claim 1, further comprising a tracking unit configured to track and detect subjects having the predetermined attribute from the video images.

4. The video image processing apparatus according to claim 1, further comprising a feature value extraction unit configured to extract a temporally changing feature value from the video images, wherein the period selection unit selects the time periods based on the feature value.

5. The video image processing apparatus according to claim 1, further comprising a specifying unit configured to specify the predetermined attribute.

6. The video image processing apparatus according to claim 1, wherein the period selection unit identifies whether or not a movement the predetermined subject performed is normal, and selects the time periods based on a result of the identification.

7. The video image processing apparatus according to claim 1, wherein the synthesizing unit determines the distribution of the time periods so that the video images from the plurality of time periods do not spatially overlap.

8. The video image processing apparatus according to claim 1, wherein the synthesizing unit determines the distribution so that the video images from the plurality of time periods are temporally synchronized.

9. The video image processing apparatus according to claim 1, wherein the synthesizing unit distributes and displays at least one from among an image, an illustration, a 3D model, or a character information as the video images from the plurality of time periods.

10. The video image processing apparatus according to claim 1, wherein the synthesizing unit can change the superimposition method for the video images from the plurality of time periods.

11. The video image processing apparatus according to claim 1, wherein the period selection unit selects the time period based on at least one of the pose, movement, expression, or items held by the predetermined subject.

12. A video image processing method that includes:
a video image acquisition step for acquiring a video image;
a period selection step for selecting, from the video images that have been acquired by the video image acquisition step, a plurality of time periods in which a predetermined subject performed a predetermined movement; and
a synthesizing step for synthesizing a video image from the plurality of time periods that have been selected by the period selection step by bringing them closer together in time.

13. A non-transitory computer readable storage medium configured to store a computer program for a video image processing apparatus to execute the following steps:
a video image acquisition step for acquiring a video image;
a period selection step for selecting, from the video images acquired in the video image acquisition step, a plurality of time periods in which a predetermined subject performed a predetermined movement; and
a synthesizing step for synthesizing a video image from the plurality of time periods that have been selected in the time period selection step by bringing them closer together in time.
